(19) United States
(12) Patent Application Publication
(10) Pub. No.: US 2025/0384179 A1
(43) Pub. Date: Dec. 18, 2025

(54) METHOD AND SYSTEM FOR PRECISELY DESIGNING INTEGRATED DIE-CASTING STRUCTURES

(71) Applicant: Hunan University Suzhou Institute, Suzhou (CN)

(72) Inventors: Shiwei XU, Suzhou (CN); Peijie XIAO, Suzhou (CN); Min WEN, Suzhou (CN); Houguo LU, Suzhou (CN); Honggui KAN, Suzhou (CN); Zhisheng RUAN, Suzhou (CN); Longbao CHEN, Suzhou (CN); Kewei LI, Suzhou (CN); Yu LIU, Suzhou (CN); Bin LI, Suzhou (CN); Rui WANG, Suzhou (CN)

(73) Assignee: Hunan University Suzhou Institute, Suzhou (CN)

(21) Appl. No.: 19/021,366

(22) Filed: Jan. 15, 2025

(30) Foreign Application Priority Data
Jun. 13, 2024 (CN) 2024107577189

(51) Int. Cl. G06F 30/17; G06F 119/22

(52) U.S. Cl. CPC G06F 30/17; G06F 2119/22

(57) ABSTRACT

The present disclosure claims a method and system for precisely designing integrated die-casting structures, which comprises (1) in a die-casting structure design module, carrying out an overall structure design; (2) establishing an integrated mechanical property influence factor database module to obtain a maximum influence factor T or P or V that affects the distribution of mechanical properties of die-castings; (3) obtaining an attenuation factor mᵢ or pᵢ or gᵢ under maximum influence factors under different dᵢs by a coupling decision-making module; and (4) optimizing design of the integrated die-casting structure in step (1) through a precise structure design module. The method and the system for precisely designing integrated die-casting structures are used for precisely optimizing the design of integrated die-casting parts, realizing lightweighting and integration of die-casting products under the condition that the mechanical properties of die-castings are ensured, which is conducive to improving design efficiency and design rationality.

### CROSS-REFERENCE TO RELATED APPLICATIONS

The application claims priority to Chinese patent application No. 2024107577189, filed on Jun. 13, 2024, the entire contents of which are incorporated herein by reference.

### TECHNICAL FIELD

The present disclosure relates to a method and a system for precisely designing integrated die-casting structures, which belong to the technical field of new energy vehicle production.

### BACKGROUND

At present, the lightweighting, integrating and large-scaling of automotive product components have become a development trend. For new energy vehicles, the integrated design of body parts can greatly reduce the number of parts, thus reducing the number of molds, and simplifying welding and splicing processes of parts in manufacturing to improve production takt and efficiency. Thanks to the development of large-tonnage die-casting equipment and technology, the integrated die-casting technology is widely favored. For example, large-size complex key load-bearing structural parts such as integrated die-cast floor and front engine compartment are gradually developing towards large size, high integration, high mechanical performance and thin wall for lightweight.

However, the structural design of traditional all-in-one die-casting is based on CAE simulation technology. For example, parts such as inner panel of a rear wheel cover, rear longitudinal beam, slab connecting plate and stiffening plate in a beam are integrated to achieve lightweight and high performance. The design and optimization work are completed through topology optimization, reinforcing rib arrangement and thickness optimization. In addition, the structural design of the gating system, overflow system and mold cavity of die-castings will affect the forming quality of die-castings. By clarifying the corresponding relationship between the structure change and the performance change of die-castings, the quality of die-castings can be regulated and controlled by optimizing the structure of die-castings, thus improving the mechanical properties of die-castings.

However, due to some inevitable defects of integrated die-castings, such as cracks, cold shuts, flashes, holes and other defects, the mechanical properties such as tensile strength, yield strength and elongation of integrated die-castings produced by actual manufacturing processes show extremely uneven characteristics, that is, the mechanical property parameters required for ideal design of integrated die-castings are quite different from the service mechanical properties of castings actually produced. Moreover, in operation, only a partial local area of an integrated die-casting suffers from large stress in a concentrated manner, and stress in most of the areas is small. If there are many defects in the key stress concentrated part, it is easy to cause failure in this part during casting operation. However, there are few defects in other parts. If the stress is not concentrated, it will lead to redundant and unreasonable structural design, resulting in waste and poor lightweighting effect of integrated die-castings.

The patent with the application publication number of CN 115292838 A discloses a design method for mold castings of a space truss structure, including the following steps: carry out a process analysis on given workpieces to determine the working direction and trimming direction of wedges; determine the wedge driving angle and draw a travel line diagram; design a space truss casting structure: design the main frame unit; design auxiliary units; design the connecting part; carry out CAE structural strength analysis and function verification for the designed space truss casting structure; and optimize the space truss casting structure according to the results of strength analysis and function verification. However, this method is not suitable for the analysis of mechanical properties of integrated die-castings, especially for the lightweighting and integrated precision design of integrated die-casting structures.

### SUMMARY

The main technical problem to be solved by the present disclosure is to provide a method and a system for precisely designing integrated die-casting structures, and the method and the system for precisely designing integrated die-casting structures are used for precisely optimizing the design of integrated die-casting parts, realizing lightweighting and integration of die-casting products under the condition that the mechanical properties of die-castings are ensured, which is conducive to improving design efficiency and design rationality, and reducing the cost of die-casting products.

In order to solve the above technical problem, the present disclosure provides a method for precisely designing integrated die-casting structures, comprising the following steps:
(1) in a die-casting structure design module, carrying out an overall structure design according to components integrated by die-castings, dividing grids on them, and performing topological optimization, static and dynamic CAE mechanical performance simulation analysis to obtain a die-casting structure that meets the design requirements; then, carrying out a mold flow analysis to extract a temperature distribution Tᵢ, a pressure distribution Pᵢ and a velocity distribution Vᵢ of the die-casting structure, defining a position of the initial integrated die-casting structure and a position of its pouring opening, determining the temperature distribution Tᵢ, the pressure distribution Pᵢ, the velocity distribution Vᵢ and an initial stress distribution nephogram Sᵢ, wherein i represents the position of the integrated die-casting structure, and extracting the linear distance dᵢ between any position of the integrated die-casting structure and the pouring opening;
(2) establishing an integrated mechanical property influence factor database module, wherein the integrated mechanical property influence factor database module is used to calculate the tensile strength attenuation factor mᵢ, yield strength attenuation factor pᵢ and elongation attenuation factor gᵢ of samples at various positions of the integrated die-casting structure, and obtain a maximum influence factor T or P or V that affects the distribution of mechanical properties of die-castings;
(3) obtaining an attenuation factor mᵢ or pᵢ or gᵢ under maximum influence factors under different dᵢs by a coupling decision-making module; and
(4) optimizing design of the integrated die-casting structure in step (1) through a precise structure design module.

Preferably, the integrated mechanical property influence factor database module in step
(2) comprises a mold flow analysis module and a mechanical property nephogram distribution module, wherein the mold flow analysis module performs a mold flow simulation analysis of the integrated die-casting structure to obtain a temperature distribution nephogram, a pressure distribution nephogram and a velocity distribution nephogram of the integrated die-casting, and establishes mapping relationships between temperature and pouring distance, pressure and pouring distance, and velocity and pouring distance based on the position of the pouring opening;
the mapping relationship between temperature and pouring distance is as follows:

$${T}_{i} = {a}_{0} + {a}_{1} {d}_{i} + {a}_{2} {d}_{i}^{2} ;$$

where Tᵢ is the temperature distribution, a₀, a₁ and a₂ are fitting constants, and dᵢ is a linear distance between any position of the die-casting structure and the pouring opening;
the mapping relationship between pressure and pouring distance is as follows:

$${P}_{i} = {b}_{0} + {b}_{1} {d}_{i} + {b}_{2} {d}_{i}^{2} ;$$

where Pᵢ is the pressure distribution, b₀, b₁ and b₂ are fitting constants, and dᵢ is a linear distance between any position of the die-casting structure and the pouring opening;
the mapping relationship between velocity and pouring distance is as follows:

$${V}_{i} = {c}_{0} + {c}_{1} {d}_{i} + {c}_{2} {d}_{i}^{2} ;$$

where Vᵢ is the velocity distribution, c₀, c₁ and c₂ are fitting constants, and dᵢ is a linear distance between any position of the die-casting structure and the pouring opening;
take dumbbell-shaped tensile samples from various positions of the integrated die-casting structure, and carry out tensile mechanical property tests on the samples at various positions, wherein based on the mechanical property test results of tensile strength Rₘⁱ, yield strength Rₚⁱ and elongation Aⁱ of the samples at various positions, and according to the distance dᵢ between each position and the pouring opening, a mechanical property nephogram distribution module is constructed, namely:

$${R}_{m}^{i} = {x}_{0} + {x}_{1} {d}_{i} + {x}_{2} {d}_{i}^{2} ;$$

where x₀, x₁ and x₂ are fitting constants, and dᵢ is a linear distance between any position of the die-casting structure and the pouring opening;

$${R}_{p}^{i} = {y}_{0} + {y}_{1} {d}_{i} + {y}_{2} {d}_{i}^{2} ;$$

where y₀, y₁ and y₂ are fitting constants, and dᵢ is a linear distance between any position of the die-casting structure and the pouring opening;

$${A}^{i} = {z}_{0} + {z}_{1} {d}_{i} + {z}_{2} {d}_{i}^{2} ;$$

where z₀, z₁ and z₂ are fitting constants, and dᵢ is a linear distance between any position of the die-casting structure and the pouring opening;
obtain the mechanical property attenuation factors mᵢ, pᵢ and gᵢ of tensile strength, yield strength and elongation of the samples at each position, respectively, where:

$$\begin{matrix}\begin{matrix}{m}_{i} = {R}_{m}^{i} / {R}_{m 0} ; \\ {p}_{i} = {R}_{p}^{i} / {R}_{p0} ;\end{matrix} \\ {g}_{i} = {A}^{i} / {A}_{0} ;\end{matrix}$$

Rₘ₀, Rₚ₀ and A₀ are ideal tensile strength, yield strength and elongation of the material, respectively;
the integrated mechanical property influence factor database module builds a relational expression according to the above parameters:

$$Δ {T}_{i} = max ( {T}_{i} ) - {T}_{i} ; {ΔP}_{i} = max ( {P}_{i} ) - {P}_{i} ; {ΔV}_{i} = max ( {V}_{i} ) - {V}_{i} ;$$

the relationships between these equations and tensile strength attenuation factor mᵢ, yield strength attenuation factor pᵢ and elongation attenuation factor gᵢ are established to find the maximum influence factor T or P or V that affects the distribution of mechanical properties of die-castings.

Preferably, the coupling decision-making module in step (3) selects the maximum influence factor T or P or V from the mechanical property influence factor database module, extracts the temperature distribution Tᵢ or pressure distribution Pᵢ or velocity distribution Vᵢ obtained in the die-casting structure design module, calculates ΔTᵢ or ΔPᵢ or ΔVᵢ, and obtains the tensile strength attenuation factor mᵢ, yield strength attenuation factor pᵢ and elongation attenuation factor gᵢ according to the integrated mechanical property influence factor database module.

Preferably, according to the die-casting structure that meets the design requirements and is obtained by the die-casting structure design module in step (4), combined with the stress distribution nephogram Sᵢ of its CAE analysis, based on the tensile strength attenuation factor mᵢ or yield strength attenuation factor pᵢ or elongation attenuation factor gᵢ of the sample at each position of the coupling decision-making module, for the die-casting structural area at 80%˜100% max(Sᵢ) in the stress distribution nephogram Sᵢ, extract the tensile strength attenuation factor threshold mᵢ or yield strength attenuation factor pᵢ or elongation attenuation factor gᵢ, and if its value is less than 0.9, thicken reinforcing ribs in this area and local parts thereof; for the integrated die-casting structural area below 40% max(Sᵢ) in the stress distribution nephogram Sᵢ, directly thin down reinforcing ribs in this area and local parts thereof; for the integrated die-casting structural area at 40%˜80% max(Sᵢ) in the stress distribution nephogram Sᵢ, extract its tensile strength attenuation factor threshold mᵢ or yield strength attenuation factor pᵢ or elongation attenuation factor gᵢ, and if its value is greater than 0.95, directly thin down reinforcing ribs in this area and local parts thereof.

The present disclosure further provides a design system used for the above-mentioned method for precisely designing integrated die-casting structures, comprising an integrated mechanical property influence factor database module, a die-casting structure design module, a coupling decision-making module and a precise structure design module, wherein the mechanical property influence factor database module comprises a mold flow analysis module and a mechanical property nephogram distribution module, and the integrated mechanical property influence factor database module, the die-casting structure design module, the coupling decision-making module and the precise structure design module are in signal communication with each other.

The present disclosure has the following beneficial effects: The method and the system for precisely designing integrated die-casting structures according to the present disclosure are used for precisely optimizing the design of integrated die-casting parts. By analyzing the tensile strength attenuation factor mᵢ, yield strength attenuation factor pᵢ and elongation attenuation factor gᵢ of a sample at each position of an integrated die-casting part, the maximum influence factor T or P or V that affects the mechanical property distribution of the die-casting is obtained, and thickness increasing or thinning treatment is performed on reinforcing ribs at each position area of the die-casting and local areas thereof. Under the condition of ensuring the mechanical properties of die-castings, realizing lightweighting and integration of die-casting products is conducive to improving design efficiency and rationality and reducing the cost of die-casting products.

### BRIEF DESCRIPTION OF DRAWINGS

A brief introduction is made below to the drawings necessary for the description of the embodiment to illustrate the technical solution in the embodiments of the present disclosure more clearly. Apparently, the figures in the following description are only some embodiments of the present disclosure, and those of ordinary skill in the art can derive other drawings from these drawings without creative work, where:

FIG. 1 is a flow chart of the method for precisely designing integrated die-casting structures according to the present disclosure;

FIG. 2 is a structural block diagram of the design system used for the method for precisely designing integrated die-casting structures according to the present disclosure.

### DETAILED DESCRIPTION OF THE EMBODIMENTS

The following is a clear and complete description of the technical solutions in the embodiments of the present disclosure. Obviously, the described embodiments are only some rather than all of the embodiments of the present disclosure. Based on the embodiments described herein, all other embodiments obtained by those of ordinary skill in the art without creative work are within the scope of the present disclosure.

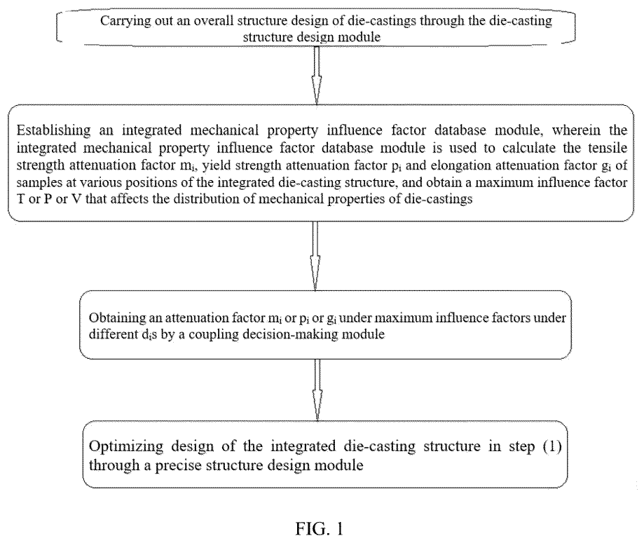

Referring to FIG. 1, an embodiment of the present disclosure includes a method for precisely designing integrated die-casting structures, which comprises the following steps:
(1) in a die-casting structure design module, carrying out an overall structure design according to components integrated by die-castings, dividing grids on them, and performing topological optimization, static and dynamic CAE mechanical performance simulation analysis to obtain a die-casting structure that meets the design requirements; then, carrying out a mold flow analysis to extract a temperature distribution Tᵢ, or a pressure distribution Pᵢ or a velocity distribution Vᵢ of the die-casting structure, defining a position of the initial integrated die-casting structure and a position of its pouring opening, determining the temperature distribution Tᵢ, the pressure distribution Pᵢ, the velocity distribution Vᵢ and an initial stress distribution nephogram Sᵢ, wherein i represents the position of the integrated die-casting structure, and extracting the linear distance dᵢ between any position of the integrated die-casting structure and the pouring opening;
(2) establishing an integrated mechanical property influence factor database module, wherein the integrated mechanical property influence factor database module is used to calculate the tensile strength attenuation factor mᵢ, yield strength attenuation factor pᵢ and elongation attenuation factor gᵢ of samples at various positions of the integrated die-casting structure, and obtain a maximum influence factor T or P or V that affects the distribution of mechanical properties of die-castings;
(3) obtaining an attenuation factor mᵢ or pᵢ or gᵢ under maximum influence factors under different dᵢs by a coupling decision-making module; and
(4) optimizing design of the integrated die-casting structure in step (1) through a precise structure design module.

Preferably, the integrated mechanical property influence factor database module in step (2) comprises a mold flow analysis module and a mechanical property nephogram distribution module, wherein the mold flow analysis module performs a mold flow simulation analysis of the integrated die-casting structure to obtain a temperature distribution nephogram, a pressure distribution nephogram and a velocity distribution nephogram of the integrated die-casting, and establishes mapping relationships between temperature and pouring distance, pressure and pouring distance, and velocity and pouring distance based on the position of the pouring opening;
the mapping relationship between temperature and pouring distance is as follows:

$${T}_{i} = {a}_{0} + {a}_{1} {d}_{i} + {a}_{2} {d}_{i}^{2} ;$$

where Ti is the temperature distribution, a0, a1 and a2 are fitting constants, and di is a linear distance between any position of the die-casting structure and the pouring opening;
the mapping relationship between pressure and pouring distance is as follows:

$${P}_{i} = {b}_{0} + {b}_{1} {d}_{i} + {b}_{2} {d}_{i}^{2} ;$$

where Pi is the pressure distribution, b0, b1 and b2 are fitting constants, and di is a linear distance between any position of the die-casting structure and the pouring opening;
the mapping relationship between velocity and pouring distance is as follows:

$${V}_{i} = {c}_{0} + {c}_{1} {d}_{i} + {c}_{2} {d}_{i}^{2} ;$$

where Vi is the velocity distribution, c0, c1 and c2 are fitting constants, and di is a linear distance between any position of the die-casting structure and the pouring opening;
take dumbbell-shaped tensile samples from various positions of the integrated die-casting structure, and carry out tensile mechanical property tests on the samples at various positions, wherein based on the mechanical property test results of tensile strength Rₘⁱ, yield strength Rₚⁱ and elongation Aⁱ of the samples at various positions, and according to the distance dᵢ between each position and the pouring opening, a mechanical property nephogram distribution module is constructed, namely:

$${R}_{m}^{i} = {x}_{0} + {x}_{1} {d}_{i} + {x}_{2} {d}_{i}^{2} ;$$

where x₀, x₁ and x₂ are fitting constants, and dᵢ is a linear distance between any position of the die-casting structure and the pouring opening;

$${R}_{p}^{i} = {y}_{0} + {y}_{1} {d}_{i} + {y}_{2} {d}_{i}^{2} ;$$

where y₀, y₁ and y₂ are fitting constants, and dᵢ is a linear distance between any position of the die-casting structure and the pouring opening;

$${A}^{i} = {z}_{0} + {z}_{1} {d}_{i} + {z}_{2} {d}_{i}^{2} ;$$

where z₀, z₁ and z₂ are fitting constants, and dᵢ is a linear distance between any position of the die-casting structure and the pouring opening;
obtain the mechanical property attenuation factors mᵢ, pᵢ and gᵢ of tensile strength, yield

strength and elongation of the samples at each position, respectively, where:

$${m}_{i} = {R}_{m}^{i} / {R}_{m 0} ;$$

$${p}_{i} = {R}_{p}^{i} / {R}_{p 0} ;$$

$${g}_{i} = {A}^{i} / {A}_{0} ;$$

Rₘ₀, Rₚ₀ and A₀ are ideal tensile strength, yield strength and elongation of the material, respectively;
the integrated mechanical property influence factor database module builds a relational expression according to the above parameters:

$$Δ {T}_{i} = max ( {T}_{i} ) - {T}_{i} ; Δ {P}_{i} = max ( {P}_{i} ) - {P}_{i} ; Δ {V}_{i} = max ( {V}_{i} ) - {V}_{i} ;$$

the relationships between these equations and tensile strength attenuation factor mᵢ, yield strength attenuation factor pᵢ and elongation attenuation factor gᵢ are established to find the maximum influence factor T or Por V that affects the distribution of mechanical properties of die-castings.

Preferably, the coupling decision-making module in step (3) selects the maximum influence factor T or P or V from the mechanical property influence factor database module, extracts the temperature distribution Tᵢ or pressure distribution Pᵢ or velocity distribution Vᵢobtained in the die-casting structure design module, calculates ΔTᵢ or ΔPᵢ or ΔVᵢ, and obtains the tensile strength attenuation factor mᵢ, yield strength attenuation factor pᵢ and elongation attenuation factor gᵢ according to the integrated mechanical property influence factor database module.

Preferably, according to the die-casting structure that meets the design requirements and is obtained by the die-casting structure design module in step (4), combined with the stress distribution nephogram Sᵢ of its CAE analysis, based on the tensile strength attenuation factor mᵢ or yield strength attenuation factor pᵢ or elongation attenuation factor gᵢ of the sample at each position of the coupling decision-making module, for the die-casting structural area at 80%˜100% max(Sᵢ) in the stress distribution nephogram Sᵢ, extract the tensile strength attenuation factor threshold mᵢ or yield strength attenuation factor pᵢ or elongation attenuation factor gᵢ, and if its value is less than 0.9, thicken reinforcing ribs in this area and local parts thereof; for the integrated die-casting structural area below 40% max(Sᵢ) in the stress distribution nephogram Sᵢ, directly thin down reinforcing ribs in this area and local parts thereof; for the integrated die-casting structural area at 40%˜80% max(Sᵢ) in the stress distribution nephogram Sᵢ, extract its tensile strength attenuation factor threshold mᵢ or yield strength attenuation factor pᵢ or elongation attenuation factor gᵢ, and if its value is greater than 0.95, directly thin down reinforcing ribs in this area and local parts thereof.

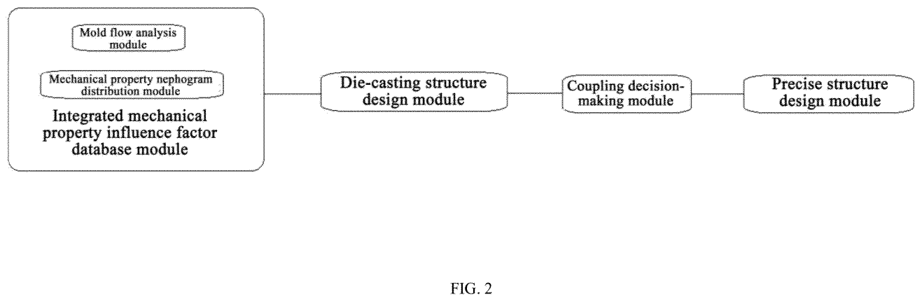

The present disclosure further provides a design system used for the above-mentioned method for precisely designing integrated die-casting structures, as shown in FIG. 2, comprising an integrated mechanical property influence factor database module, a die-casting structure design module, a coupling decision-making module and a precise structure design module, wherein the mechanical property influence factor database module comprises a mold flow analysis module and a mechanical property nephogram distribution module, and the integrated mechanical property influence factor database module, the die-casting structure design module, the coupling decision-making module and the precise structure design module are in signal communication with each other.

The method and the system for precisely designing integrated die-casting structures according to the present disclosure, by analyzing the tensile strength attenuation factor mᵢ, yield strength attenuation factor pᵢ and elongation attenuation factor gᵢ of a sample at each position of an integrated die-casting part, obtain the maximum influence factor T or P or V that affects the mechanical property distribution of the die-casting, and perform thickness increasing or thinning treatment on reinforcing ribs at each position area of the die-casting and local areas thereof. Under the condition of ensuring the mechanical properties of die-castings, realizing lightweighting and integration of die-casting products is conducive to improving design efficiency and rationality and reducing the cost of die-casting products.

1. A method for precisely designing and processing integrated die-casting structures, comprising the following steps of:
(1) in a die-casting structure design module, carrying out an overall structure design according to components integrated by die-castings, dividing grids on them, and performing topological optimization, static and dynamic CAE mechanical performance simulation analysis to obtain a die-casting structure that meets the design requirements: then, carrying out a mold flow analysis to extract a temperature distribution Tᵢ, a pressure distribution Pᵢ and a velocity distribution Vᵢ of the die-casting structure, defining a position of the initial integrated die-casting structure and a position of its pouring opening, determining the temperature distribution Tᵢ, the pressure distribution Pᵢ, the velocity distribution Vᵢ and an initial stress distribution nephogram Sᵢ, wherein i represents the position of the integrated die-casting structure, and extracting the linear distance dᵢ between any position of the integrated die-casting structure and the pouring opening:
(2) establishing an integrated mechanical property influence factor database module, wherein the integrated mechanical property influence factor database module is used to calculate the tensile strength attenuation factor mᵢ, yield strength attenuation factor pᵢ and elongation attenuation factor gᵢ of samples at various positions of the integrated die-casting structure, and obtain a maximum influence factor T or P or V that affects the distribution of mechanical properties of die-castings:
(3) obtaining an attenuation factor mᵢ or pᵢ or gᵢ under maximum influence factors under different dis by a coupling decision-making module: (4) optimizing design of the integrated die-casting structure in step (1) through a precise structure design module, wherein the integrated mechanical property influence factor database module in step (2) comprises a mold flow analysis module and a mechanical property nephogram distribution module, wherein the mold flow analysis module performs a mold flow simulation analysis of the integrated die-casting structure to obtain a temperature distribution nephogram, a pressure distribution nephogram and a velocity distribution nephogram of the integrated die-casting, and establishes mapping relationships between temperature and pouring distance, pressure and pouring distance, and velocity and pouring distance based on the position of the pouring opening:
the mapping relationship between temperature and pouring distance is as follows:
$${T}_{i} = {a}_{0} + {a}_{1} {d}_{i} + {a}_{2} {d}_{i}^{2}$$
where T is the temperature, a₀, a₁ and a₂ are fitting constants, and dᵢ is a linear distance between any position of the die-casting structure and the pouring opening:
the mapping relationship between pressure and pouring distance is as follows:
$${P}_{i} = {b}_{0} + {b}_{1} {d}_{i} + {b}_{2} {d}_{i}^{2}$$
where P is the pressure, b₀, b₁ and b₂ are fitting constants, and dᵢ is a linear distance between any position of the die-casting structure and the pouring opening:
the mapping relationship between velocity and pouring distance is as follows:
$${V}_{i} = {c}_{0} + {c}_{1} {d}_{i} + {c}_{2} {d}_{i}^{2}$$
where V is the velocity, c₀, c₁ and c₂ are fitting constants, and dᵢ is a linear distance between any position of the die-casting structure and the pouring opening:
taking dumbbell-shaped tensile samples from various positions of the integrated die-casting structure, and carrying out tensile mechanical property tests on the samples at various positions, wherein based on the mechanical property test results of tensile strength Rₘⁱ, yield strength Rₚⁱ and elongation Aⁱ of the samples at various positions, and according to the distance dᵢ between each position and the pouring opening, a mechanical property nephogram distribution module is constructed, namely:
$${R}_{m}^{i} = {x}_{0} + {x}_{1} {d}_{i} + {x}_{2} {d}_{i}^{2}$$
where x₀, x₁ and x₂ are fitting constants, and dᵢ is a linear distance between any position of the die-casting structure and the pouring opening:
$${R}_{p}^{i} = {y}_{0} + {y}_{1} {d}_{i} + {y}_{2} {d}_{i}^{2}$$
where y₀, y₁ and y₂ are fitting constants, and dᵢ is a linear distance between any position of the die-casting structure and the pouring opening:
$${A}^{i} = {z}_{0} + {z}_{1} {d}_{i} + {z}_{2} {d}_{i}^{2}$$
where z₀, z₁ and z₂ are fitting constants, and dᵢ is a linear distance between any position of the die-casting structure and the pouring opening:
obtain the mechanical property attenuation factors mᵢ, pᵢ and gᵢ of tensile strength, yield strength and elongation of the samples at each position, respectively, where:
$${m}_{i} = {R}_{m}^{i} / {R}_{m 0}$$
$${p}_{i} = {R}_{p}^{i} / {R}_{p 0}$$
$${g}_{i} = {A}^{i} / {A}_{0}$$
Rm0, Rp0 and A0 are ideal tensile strength, yield strength and elongation of the material, respectively:
wherein the integrated mechanical property influence factor database module builds a relational expression according to the above parameters: ΔTᵢ=max(Tᵢ)−Tᵢ; ΔPᵢ=max(Pᵢ)−Pᵢ; ΔVᵢ=max(Vᵢ)−Vᵢ
the relationships between these equations and tensile strength attenuation factor mᵢ, yield strength attenuation factor pᵢ and elongation attenuation factor gᵢ are established to find the maximum influence factor T or P or V that affects the distribution of mechanical properties of die-castings,
performing thickness increasing or thinning treatment on reinforcing ribs at each position area and local area of die-casting products according to the maximum influence factor T or P or V, to realize light-weighting and integration of the die-casting products, under the condition of ensuring the mechanical properties.

2. The method for precisely designing and processing integrated die-casting structures according to claim 1, wherein the coupling decision-making module in step (3) selects the maximum influence factor T or P or V from the mechanical property influence factor database module, extracts the temperature distribution Tᵢ or pressure distribution Pᵢ or velocity distribution Vᵢ obtained in the die-casting structure design module, calculates ΔTᵢ or ΔPᵢ or ΔVᵢ, and obtains the tensile strength attenuation factor mᵢ, yield strength attenuation factor pᵢ and elongation attenuation factor gᵢ according to the integrated mechanical property influence factor database module.

3. The method for precisely designing and processing integrated die-casting structures according to claim 1, wherein according to the die-casting structure that meets the design requirements and is obtained by the die-casting structure design module in step (4), combined with the stress distribution nephogram Si of its CAE analysis, based on the tensile strength attenuation factor mi or yield strength attenuation factor pi or elongation attenuation factor gi of the sample at each position of the coupling decision-making module, for the die-casting structural area at 80%˜100% max(Si) in the stress distribution nephogram Si, extract the tensile strength attenuation factor threshold mi or yield strength attenuation factor pi or elongation attenuation factor gi, and if its value is less than 0.9, thicken reinforcing ribs in this area and local parts thereof; for the integrated die-casting structural area below 40% max(Si) in the stress distribution nephogram Si, directly thin down reinforcing ribs in this area and local parts thereof; for the integrated die-casting structural area at 40%˜80% max(Si) in the stress distribution nephogram Si, extract its tensile strength attenuation factor threshold mi or yield strength attenuation factor pi or elongation attenuation factor gi, and if its value is greater than 0.95, directly thin down reinforcing ribs in this area and local parts thereof.

4. A design system used for the method for precisely designing and processing integrated die-casting structures according to claim 1, comprising an integrated mechanical property influence factor database module, a die-casting structure design module, a coupling decision-making module and a precise structure design module, wherein the mechanical property influence factor database module comprises a mold flow analysis module and a mechanical property nephogram distribution module, and the integrated mechanical property influence factor database module, the die-casting structure design module, the coupling decision-making module and the precise structure design module are in signal communication with each other.
